(19) United States
(12) Patent Application Publication
(10) Pub. No.: US 2004/0209013 A1
(43) Pub. Date: Oct. 21, 2004

(54) Ink-jet recording sheet and production method of the same

(75) Inventors: Yoshinori Tsubaki, Tokyo (JP); Masayuki Ushiku, Yokohama-shi (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Holdings, Inc., Tokyo (JP)

(21) Appl. No.: 10/823,340

(22) Filed: Apr. 12, 2004

(30) Foreign Application Priority Data
Apr. 16, 2003 (JP) JP2003-111468

(51) Int. Cl. B41M 5/00

(52) U.S. Cl. 428/32.24

(57) ABSTRACT

An ink-jet recording sheet containing a support having thereon a first porous ink receptive layer and a second porous ink receptive layer in that order, the first porous ink receptive layer and the second porous ink receptive layer each containing, (i) inorganic microparticles; and (ii) a hydrophilic binder which is cross-linked by irradiation with ionization radiation, wherein an average particle diameter of second particles of the inorganic microparticles in the second porous ink receptive layer is smaller than an average particle diameter if second particles of the inorganic microparticles in the first porous ink receptive layer.

### TECHNICAL FIELD

The present invention relates to an ink-jet recording sheet (hereinafter also simply referred to as a recording sheet) and its production method, and in more detail to an ink-jet recording sheet having a plurality of porous layers which minimizes cracking, results in high glossiness and excellent ink absorbability and exhibits improved layer folding and fracture resistance and improved dimensional stability and its production method.

### BACKGROUND

In recent years, in ink-jet recording systems, image quality has increasingly been improved and is approaching the quality of silver salt photography. As a means to achieve such silver salt photographic quality employing these ink-jet recording systems, technical improvement is increasingly performed for employed recording sheets.

As supports employed for the aforesaid recording sheets, water absorptive supports such as paper, as well as non-water absorptive supports such as polyester film or resin coated paper, are generally known. The former exhibits the advantage of high ink absorption capability since supports themselves can absorb ink. On the other hand, problems occur in which wrinkling (also called cockling) results after printing due to water absorbability of supports, whereby it is difficult to produce high quality prints. In addition, problems occur in which friction tends to occur between the recording head and the print surface, along with the cockling during printing. On the other hand, when non-water absorptive supports are used, the problems described above do not occur resulting in an advantage capable of producing high quality prints.

On the other hand, as an example of a porous layer provided on a support, an ink-jet sheet is invented in which hydrophilic binders such as gelatin or polyvinyl alcohol (PVA) are applied onto a highly smoothed support to form a porous layer. In this type of recording sheet, printed ink is absorbed utilizing swellability of the binders. However, since the binders are water-soluble resins, ink is not dried as desired after printing. In addition, formed images and layers are not sufficiently water resistant. Further, since the printing rate of current ink-jet printers is high, the rate of ink absorption achieved by swelling of binders cannot not keep up with the amount and rate of ejected ink. As a result, problems occur in which adaptation for printers is lost to result in ink flooding and images with a mottled appearance.

On the other hand, Japanese Patent Publication Open to Public Inspection (hereinafter referred to as JP-A) No. 63-18387 discloses a paper recording sheet provided with a receptive layer comprising modified polyvinyl alcohol and a water resistant agent. Further, JP-A No. 1-286886 discloses a water-based ink recording sheet comprising a receptive layer prepared by employing a hydrophilic binder which undergoes crosslinking by ionization radiation. By employing hardened binders as a receptive layer, water resistance of images and layers are enhanced as desired. However, since ink is primarily absorbed utilizing swellability of resins, ink absorbability itself is not improved.

Contrary to the type of ink-jet recording sheets which absorb ink utilizing swellability of the aforesaid water-based resins, JP-A No. 10-119423 proposes a paper recording sheet comprising a porous layer having a minute void structure as an ink absorptive layer, resulting in high ink absorbability as well as fast ink drying. Consequently, this method is becoming one of the common methods which result in image quality most similar to that of silver salt photography.

The aforementioned porous layer is mainly formed by employing hydrophilic binders and minute particles. Known as minute particles are minute inorganic or organic particles. However, minute inorganic particles are preferably employed due to realization of a decrease in the particle size and of high glossiness of the porous layer. Further, by employing hydrophilic binders in a relatively small amount with respect to the aforementioned minute inorganic particles, voids are formed among the minute inorganic particles, whereby a porous layer of a high void ratio results.

Commonly, as the diameter of the aforesaid minute inorganic particles increases, the pore diameter formed among particles also increases to result in an increase in an ink absorption rate. However, a drawback is that glossiness is deteriorated.

In order to overcome the aforesaid drawbacks, an ink-jet recording sheet is proposed (refer, for example, to Patent Document 1) in which drawbacks regarding glossiness and absorption rate are overcome by separating functions in such a manner that a minute particle layer comprised of relatively large particles, which achieves absorption, is formed as a lower layer and a particle layer comprised of relatively smaller particles, which results in the desired glossiness, is formed as an upper layer. The inventors of the present invention conducted investigation and made the following discovery. Even in the case of the aforesaid function separation layers, when both layers are simultaneously coated at a wet state and dried to form a porous layer, the resulting rate of absorption is lower than that of the individually formed layer due to the interaction between the upper layer and the lower layer.

On the other hand, an ink-jet recording sheet is proposed (refer, for example, to Patent Document 2) which is prepared by bringing a porous layer provided on a specular surface metal roller or a highly smoothed synthetic resinous film into pressure contact with a gloss generating layer comprised of hydrophilic compounds having at least two ethylenic double bonds in the molecule which undergoes polymerization by ionization radiation. However, even in the aforesaid method in which the relatively large particle containing layer and the relatively small particle containing layer are separately formed and after drying them, both layers are overlapped, during overlapping of both layers, binders are subjected to diffusion between the layers due to the absence of a component diffusion retarding process such as gelling of the lower layer, whereby voids are filled to decrease the void ratio. Alternatively, required are specular surface metal rollers and particular apparatuses for overlapping both layers, whereby many problems for process adaptability occur.

Reasons for degradation of ink absorbability due to overlapping layers having different particle diameters, as described above, are not yet clearly understood. However, it is assumed that void portions are buried due to microscopic mixing at each interlayer or migration of diffusion components between layers, whereby ink absorption is hindered.

Specifically, when low molecular weight components are employed as a binder or when a component diffusion retarding process such as gelling is not used in the production process, the aforesaid problems occur markedly.

(Patent Document 1)

JP-A No. 6-183131 (claims)

(Patent Document 1)

JP-A No. 8-169175 (claims)

### SUMMARY OF THE INVENTION

Subsequently, an object of the present invention is to provide a ink-jet recording sheet, comprising a porous layer, which minimizes layer cracking during production, and exhibits excellent ink absorbability, wet curl resistance, and folding and fracture resistance, and a production method of the same.

The aforesaid problems of the ink-jet recording sheet were solved employing the following structures.

An aspect of the present invention is an ink-jet recording sheet comprising a support having thereon a first porous ink receptive layer (lower layer) and a second porous ink receptive layer (upper layer) in that order, the first porous ink receptive layer and the second porous ink receptive layer each containing,

(i) inorganic microparticles; and

(ii) a hydrophilic binder which is cross-linked by irradiation with ionization radiation,

wherein an average particle diameter of second particles of the inorganic microparticles in the second porous ink receptive layer is smaller than an average particle diameter of second particles of the inorganic microparticles in the first porous ink receptive layer.

Another aspect of the present invention is a method for producing an ink-jet recording sheet comprising the steps of:

(a) coating simultaneously a first composition and a second composition on a support so as to obtain a first porous ink receptive layer and a second porous ink receptive layer, the first composition and the second composition each containing,

(i) inorganic microparticles; and

(ii) a hydrophilic binder;

(b) irradiating the porous ink receptive layers with ionization radiation so as to cross-link the hydrophilic binder; and

(c) drying the porous ink receptive layers,

wherein an average particle diameter of second particles of the inorganic microparticles in the second porous ink receptive layer is smaller than an average particle diameter of second particles of the inorganic microparticles in the first porous ink receptive layer.

Further features of the present invention will become apparent from the detailed description.

The structures set out in the dependent claims of the present invention are also preferred embodiments of the present invention.

The inventors of the present invention conducted diligent investigations to overcome the aforesaid drawbacks and discovered the following. By employing an ink-jet recording sheet which comprises a support having thereon at least two porous layers, in which the porous layer is comprised of minute inorganic particles and hydrophilic binders which have undergone crosslinking via ionization radiation, and the average secondary particle diameter of minute inorganic particles in the aforesaid porous layer which occupies the upper portion is smaller than the average secondary particle diameter of inorganic particles of the aforesaid porous layer which occupies the lower portion, even in the case of high speed coating at a relatively high layer thickness, it was possible to realize an ink-jet recording sheet having porous layers which minimized formation of layer cracking during production, and exhibited high ink absorbability, high wet curl resistance, and folding and fracture resistance. Consequently, the present invention was achieved.

### DESCRIPTION OF EXEMPLARY EMBODIMENTS

The present invention will now be detailed.

The structures of the preferred embodiments of the present invention are as follows.

The ink-jet recording sheet, wherein a polymerization degree of the hydrophilic binder is not smaller than 500 and a ratio of cross-linking conversion of the hydrophilic binder is not more than 4 mol % based on the total mol of the hydrophilic binder.

The ink-jet recording sheet, wherein the first porous ink receptive layer and the second porous ink receptive layer are provided using a simultaneous multilayer coating method.

The ink-jet recording sheet, wherein the inorganic microparticles contained in the second porous ink receptive layer are silica or alumina.

The ink-jet recording sheet, wherein the first porous ink receptive layer and the second porous ink receptive layer each has a void volume per unit area of 15-40 ml/m².

The ink-jet recording sheet, wherein the support is a non-absorptive support.

An ink-jet recording sheet comprising a support having thereon a first porous ink receptive layer and a second porous ink receptive layer in that order, the first porous ink receptive layer and the second porous ink receptive layer each containing,

(i) inorganic microparticles; and

(ii) a hydrophilic binder which is cross-linked by irradiation with ionization radiation,

wherein an average particle diameter of second particles of the inorganic microparticles in the second porous ink receptive layer is smaller than an average particle diameter of second particles of the inorganic microparticles in the first porous ink receptive layer; a polymerization degree of the hydrophilic binder is not smaller than 500 and a ratio of cross-linking conversion of the hydrophilic binder is not more than 4 mol % based on the total mol of the hydrophilic binder; and the first porous ink receptive layer and the second porous ink receptive layer are provided using a simultaneous multilayer coating method.

The ink-jet recording sheet, wherein the inorganic microparticles contained in the first porous ink receptive layer are silica or alumina.

The ink-jet recording sheet, wherein the first porous ink receptive layer and the second porous ink receptive layer each has a void volume of per unit area of 15-40 ml/m².

The ink-jet recording sheet, wherein the support is a non-absorptive support.

The method for producing an ink-jet recording sheet, wherein a polymerization degree of the hydrophilic binder is not smaller than 500 and a ratio of cross-linking conversion of the hydrophilic binder is not more than 4 mol % based on the total mol of the hydrophilic binder.

The method for producing an ink-jet recording sheet, wherein the irradiating step (b) is carried out when a density of a solid portion in the porous ink receptive layers is in a range of 5 to 90 weight % based on the total weight of the porous ink receptive layers.

The method for producing an ink-jet recording sheet, wherein the inorganic microparticles contained in the second porous ink receptive layer are silica or alumina.

The method for producing an ink-jet recording sheet, wherein the first porous ink receptive layer and the second porous ink receptive layer each has a void volume of per unit area of 15-40 ml/m².

The method for producing an ink-jet recording, wherein the support is a non-absorptive support.

A method for producing an ink-jet recording sheet comprising the steps of:

(a) coating simultaneously a first composition and a second composition on a support so as to obtain a first porous ink receptive layer and a second porous ink receptive layer, the first composition and the second composition each containing,

(i) inorganic microparticles; and

(ii) a hydrophilic binder;

(b) irradiating the porous ink receptive layers with ionization radiation so as to cross link the hydrophilic binder; and

(c) drying the porous ink receptive layers,

wherein an average particle diameter of second particles of the inorganic microparticles in the second porous ink receptive layer is smaller than an average particle diameter of second particles of the inorganic microparticles in the first porous ink receptive layer; and a polymerization degree of the hydrophilic binder is not smaller than 500 and a ratio of cross-linking conversion of the hydrophilic binder is not more than 4 mol % based on the total mol of the hydrophilic binder,

wherein the irradiating step (b) is carried out when a density of a solid portion in the porous ink receptive layers is in a range of 5 to 90 weight % based on the total weight of the porous ink receptive layers.

The method for producing an ink-jet recording, wherein the inorganic microparticles contained in the second porous ink receptive layer are silica or alumina.

The method for producing an ink-jet recording, wherein the first porous ink receptive layer and the second porous ink receptive layer each has a void volume per unit area of 15-40 ml/m².

The method for producing an ink-jet recording sheet, wherein the support is a non-absorptive support.

The ink-jet recording sheet of the present invention is prepared by applying onto a support a plurality of layers, employing a porous layer-forming water-based liquid coating compositions comprising hydrophilic binders, which have undergone crosslinking by ionization radiation, and minute organic particles, whereby a porous layer having voids is formed.

First, minute inorganic particles according to the present invention will be described.

The recording sheet of the present invention is characterized in that the average secondary particle diameter of minute inorganic particles in the porous layer which occupies the upper portion is structured to be smaller than the average diameter of the secondary particle in the porous layer which occupies the lower portion.

Listed as minute inorganic particles usable in the present invention may be, for example, white inorganic pigments such as precipitated calcium carbonate, calcium carbonate heavy, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, silica (for example, synthetic non-crystalline silica and colloidal silica), alumina, colloidal alumina, pseudo-boehmite, aluminum hydroxide, lithopone, zeolite, or magnesium hydroxide.

In view of low cost and realization of high reflection density, preferred as the minute inorganic particles according to the present invention are minute particles at a low refractive index. Further, it is preferable that they are comprised of silica or alumina.

Silica employed in the present invention refers to either wet process silica which is synthesized employing a precipitation method or a gelling method while employing sodium silicate as a raw material or gas phase method silica. Examples of commercially available wet process silica include Fine Sil, manufactured by Tokuyama Ltd., as a precipitation method silica and NIGEL, manufactured by Nippon Silica Industrial Co., Ltd., as a gelling method silica. The precipitation method silica is characterized as silica particles which are prepared in such a manner that the secondary aggregates are formed employing primary particles at a size of about 10- about 60 nm, while the gelling method silica is characterized as silica particles which are prepared in such a manner that the secondary aggregates are formed employing primary particles at a size of about 3- about 10 nm.

The lower limit of the primary particle diameter of the wet process silica is not particularly limited. It is preferable that in view of production stability of silica particles, the resulting diameter is at least 3 nm and in view of transparency of the layer, the resulting diameter is at most 50 nm. Wet process silica, synthesized by employing the gelling method, is more preferred since generally, the resulting primary particle diameter tends to be smaller than that prepared by the precipitation method.

Gas phase method silica, as described herein, refers to one which is synthesized by a combustion method employing silicon tetrachloride and hydrogen as raw materials, and is commercially available, for example, under the Aerosil Series, manufactured by Nippon Aerosil Co., Ltd.

In order to prepare a porous layer of a high void ratio, the specific surface area determined by the BET method is preferably less than 400 m²/g. Alternatively, the isolated silanol group ratio prior to dispersion is preferably 0.5-2.0, is more preferably 0.5-1.5, and is most preferably 0.5-1.1. In view of realization of glossiness similar to silver salt photography, the lower limit of the specific surface area is preferably 40 m²/g. The BET method, as described in present invention, refers to the method which determines the specific surface area employing a method which obtains the surface area per g based on a gas phase adsorption isotherm. Further, in the gas phase method silica having the specific surface area in this range, the variation coefficient in the primary particle size distribution is preferable at most 0.4 so that the void ratio can be increased. Incidentally, the aforesaid variation coefficient is not applicable to the wet process silica, since primary particles themselves exhibit pore diameter.

It is possible to obtain the isolated silanol group ratio in the present invention utilizing FT-IR. Namely, silica is dried at 120° C. for 24 hours and FT-IR of the dried silica is determined.

Specifically, silica powder is dried at 120° C. for 24 hours, and measurement is carried out by allowing a small amount of the aforesaid dried silica to adhere to a KRS-5 window plate. When silica is diluted with KBr, moisture in KBr reacts with the isolated silanol group. Consequently, determination is carried out without dilution. An infrared absorption spectrophotometer (FT-IR-4100, manufactured by JASCO Co.) is employed as a measurement apparatus and measurement in the range of 1000-4000 cm⁻¹ is carried out employing a transmission method. Subsequently, a base line is made by connecting absorbance obtained in such a manner that a 3746 cm⁻¹ peak assigned to the isolated silanol group is subjected to base line treatment via valley crossing, and each absorbance at the valley near 3750 cm⁻¹, the valley near 2120 cm⁻¹, and the valley near 1500 cm⁻¹, and absorbance at 1870 cm⁻¹ assigned to the stretching vibration of siloxane is then determined. The isolated silanol group ratio according to the present invention refers to the ratio of absorbance at 3750 cm⁻¹ assigned to Si—OH to absorbance at 1870 cm⁻¹ assinged to Si—O—Si, and is represented by the following formula.

Isolated silanol group ratio=absorbance at 3746 cm⁻¹/absorbsance at 1870 cm⁻¹

Incidentally, it is possible to control the isolated silanol group ratio related to the present invention by varying the moisture content of the aforesaid gas phase method silica.

Examples of methods to control the moisture content include a method to spray water vapor onto silica, a method to continuously spray water vapor onto silica during conveyance, and a method to spray, under aeration, water vapor onto silica which was charged into a tightly sealed batch. It is also preferable to control the moisture content of gas phase method silica by storing the aforesaid silica at a humidity of 20-60 percent for at least three days.

The gas phase method silica exhibits a feature in which its secondary aggregates can be dispersed employing lower energy compared to the wet process silica, since they are formed via weak interaction, compared to the wet process silica.

The variation coefficient in the primary particle size distribution of the gas phase method silica is determined as follows. A section or surface of a void layer is observed employing an electron microscope and the diameter of 1,000 random primary particles is determined. Subsequently, the aforesaid variation coefficient is obtained by dividing the standard deviation of the resulting particle size distribution by the number average particle diameter. Further, the average diameter of the primary particles and the secondary particles, which are secondary aggregates, of silica is obtained in the same manner as above. Namely, the section or surface of a void layer is observed employing an electron microscope and the desired values are obtained based on the diameter of 100 random particles. Each particle diameter, as described herein, is represented by the diameter of the circle which has the same area as the projected area of each particle.

Further, in view of transmission of ionization radiation, the average diameter of secondary particles is preferably at most 300 nm.

Further, it is preferable to control the water content of gas phase method silica by storing the aforesaid silica at a humidity of 20-60 percent for at least three days.

On the other hand, alumina which may preferably be used in the recording sheet of the present invention, as described herein, refers to aluminum oxide and hydrates thereof. Employed are those which are crystalline or non-crystalline, and amorphous, spherical, tabular, or acicular. Particularly preferred are tabular alumina hydrates at an aspect ratio of at least 2 and an average diameter of the primary particles of 5-30 nm, as well as gas phase method alumina.

The content of the aforesaid minute inorganic particles in a water-based liquid coating composition is commonly 5-40 percent by weight, and is particularly preferably 7-30 percent by weight.

The recording sheet of the present invention is characterized in an embodiment in which average secondary particle diameter r₁ of minute inorganic particles of the porous layer which occupies the upper portion is smaller than average secondary particle diameter r₂ of minute inorganic particles in the porous layer which occupies the lower portion. Further, r₁/r₂ is preferably at most 0.98, and is more preferably at most 0.80.

Water-soluble hydrophilic binders crosslinked by ionization radiation which are employed in the porous layer according to the present invention refer to water-soluble resins which undergo reaction to result in crosslinking under exposure to ionization radiation such as ultraviolet radiation or electron beams, and resins of which water solubility is lowered after crosslinking than prior to crosslinking. However, it is preferable that the aforesaid resins maintain sufficient hydrophilicity to ink after crosslinking.

Employed as such resins may be crosslinking group-modified polymers which undergo crosslinking by radiation via a modifying group while polyvinyl alcohol and the like is subjected to action of a modifying group of a photodimerization type, a photodecomposition type, a photodepolymerization type, a photomodification type, or a photopolymerization type, and polymers which are subjected to direct crosslinking by electron beams. Of these, preferred are photodimerization or photopolymerization type compounds.

Preferred as photodimerization type ionization radiation crosslinking type resins are diazo type compounds or compounds introduced with a cinnamoyl group, a stilbazonium group or a stilquinolium group.

Specific compounds are those described in JP-A No. 60-129742 in which a stilbazonium group is introduced into a polyvinyl alcohol structure. Listed as such compounds are the photosensitive resins having a unit represented by General Formula (1) described below in the molecule.

General Formula (1)

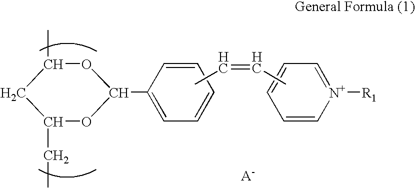

In aforesaid General Formula (1), R₁ represents an alkyl group having 1-4 carbon atoms and A⁻ represents an anionic group.

Further, listed as photopolymerization type ionization radiation crosslinking type resins may be those having a unit represented by General Formula (2) below, described in JP-A No. 2000-181062, in the molecule.

General Formula (2)

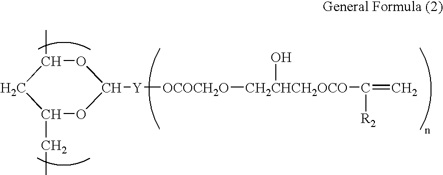

In aforesaid General Formula (2), R₂ represents a methyl group or a hydrogen atom, Y represents an aromatic ring or a simple linking unit, and n represents 1 or 2.

Listed examples of an aromatic ring represented by Y are shown below.

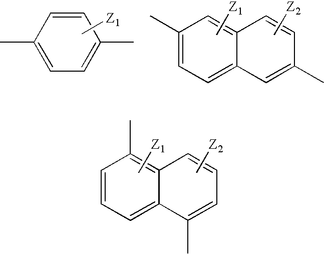

Each Z₁ and Z₂ is independently a methyl group, an ethyl group or a halogen atom.

Listed examples of a unit contained in the cross-linking type resins are shown below.

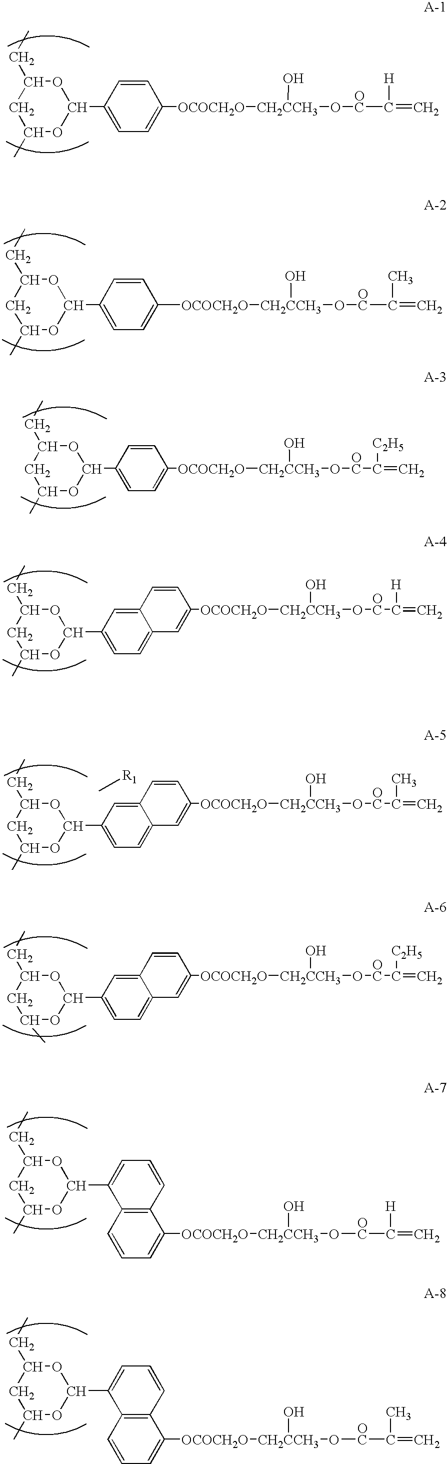

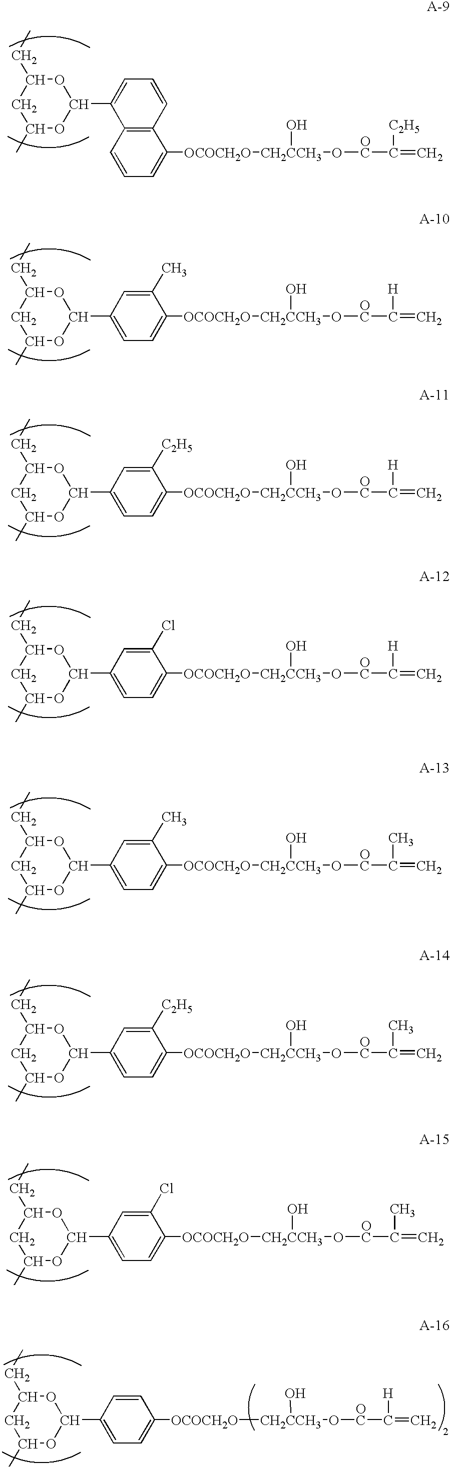

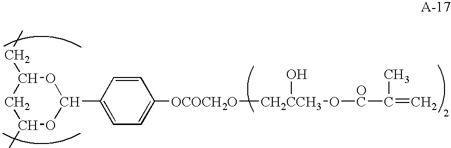

In the hydrophilic binders according to the present invention, the degree of polymerization of PVA as a mother nucleus is preferably at least 500, and is more preferably 1,700.

In the hydrophilic binders according to the present invention, the modification ratio of the ionization radiation reacting crosslinking group is preferably at most 4 mol percent with respect to the segment, and is more preferably 0.01-1 mol percent.

By employing the hydrophilic binders, at the degree of polymerization specified above, which satisfy the condition of an ionization radiation reacting crosslinking group for the segment, it is possible to decrease the crosslinking density of a coating to result in formation of a loose three-dimensional crosslinking structure, whereby the flexibility of the resulting dried layer increases. As a result, it is possible to markedly improve folding and fracture resistance of the dried layer. Further, since it is possible to decrease the crosslinking density, it is possible to improve the balance between the employed support and the moisture absorbing characterisctics or contraction and expansion properties. As a result, it is possible to improve curling characteristics.

Further, by decreasing the difference in crosslinking density and the degree of crosslinking between the upper layer and the lower layer, it is possible to markedly improve dimensional stability under humidity, or so-called curl characteristics of recording sheets.

Incidentally, in the present invention, conventional hydrophilic resins known in the art may simultaneously be employed in a range which does not adversely affect the effects desired for the present invention.

In the porous layer according to the present invention, the ratio of minute inorganic particles to hydrophilic binders is preferably 2-50 times in terms of weight ratio. When the weight ratio is at least a factor of two, the void ratio of a porous layer is acceptable to tend to achieve the sufficient void volume, whereby it is possible to avoid sealing of voids due to swelling of excessive hydrophilic binders during ink-jet recording. On the other hand, an aforesaid ratio of at most a factor of 50 is preferable since cracking tends not to result when a relatively thick porous layer is coated. The ratio of minute silica particles to hydrophilic binders is particularly preferably 2.5-20 times. Further, in view of folding and fracture resistance of the coated layer, the aforesaid ratio is preferably a factor of 5-15.

It is preferable that the voids of the porous layer according to the present invention have a volume of 15-40 ml/m² of the coated layer. The volume, as described herein, is defined by the volume of generated air bubbles when the coated layer at a unit volume is immersed in water, or the liquid transfer amount during 2-second contact time when a recording sheet is measured employing Liquid Absorption Test Method (the Bristow method) of Paper and Paper Board specified in J. TAPPI 51.

Employed as supports usable for the ink-jet recording sheet of the present invention may be water absorptive supports (for example, paper) as well as non-water absorptive supports. However, non-water absorptive supports are preferred since it is possible to prepare higher quality prints.

Listed as preferably employed non-water absorptive supports are, for example, polyester based film, diacetate based film, triacetate based film, polyolefin based film, acryl based film, polycarbonate based film, polyvinyl chloride based film, or polyimide based film, transparent film or opaque film comprised of materials such as cellophane or celluloid, or resin coated paper which is prepared by coating both sides of base paper with olefin resins, so-called RC paper.

When the aforesaid water-based liquid coating composition is applied onto the above-mentioned support, to increase the adhesion strength between the support surface and the coated layer, it is preferable that the support surface be subjected to corona discharge and subbing treatments. Further, the ink-jet recording sheet of the present invention may comprise a tinted support.

Supports preferably employed in the present invention include transparent polyester film, opaque polyester film, opaque polyolefin resin film, and a paper support in which both sides of the paper are laminated with polyolefin resins.

Non-water absorptive paper supports laminated with polyethylene, which is a representative of the most preferred polyolefin resins, will now be described.

Base paper employed for the paper support is made employing wood pulp as a main raw material and if desired, synthetic pulp such as polypropylene or synthetic fiber such as nylon or polyester together with the aforesaid wood pulp. Employed as the wood pulp may be, for example, any of LBKP, LBSP, NBKP, NBSP, LDP, NDP, LUKP, or NUKP. However, it is preferable to use LBKP, NBSP, LBSP, NDP, or LDP, all of which comprise a relatively large amount of short fibers. However, the ratio of LBSP or LDP is preferably 10-70 percent by weight.

Preferably employed as the aforesaid pulp is chemical pulp (sulfate pulp and sulfite pulp) with minimal impurities. Further, useful is pulp which is subjected to a bleaching treatment to enhance whiteness.

It is possible to suitably incorporate into base paper sizing agents such as higher fatty acids or alkyl ketene dimers, white pigments such as calcium carbonate, talc, or titanium oxide, paper strengthening agents such as starch, polyacrylamide, or polyvinyl alcohol, optical brightening agents, moisture retention agents such as polyethylene glycol, dispersing agents, and softening agents such as quaternary ammonium.

The freeness of pulp used for paper making is preferably 200-500 ml under the specification of CSF, while regarding fiber length after beating, the sum of weight percent of 24 mesh residue and weight percent of 42 mesh residue, which are specified in JIS P 8207, is preferably 30-70 percent. Incidentally, weight percent of 4 mesh residue is preferably 20 weight percent or less.

The basic weight of base paper is preferably 30-250 g, and is particularly preferably 50-200 g, while the thickness of the base paper is preferably 40-250 μm. Base paper may be given high smoothness employing calender finishing during or after paper making. The density of base paper is customarily 0.7-1.2 g/cm³ (in accordance with the method specified in JIS P 8118). Further, the stiffness of base paer is preferably 20-200 g under conditions specified in JIS P 8143. Surface sizing agents may be applied onto the surface of the base paper. Employed as surface sizing agents may be the same ones as those which can be incorporated into the base paper. The pH of base paper, when determined by the hot water extraction method specified in JIS P 8113, is preferably 5-9.

Polyethylene which is employed to cover the obverse and reverse surface of base paper is mainly comprised of low density polyethylene (LDPE) or high density polyethylene (HDPE). However, it is possible to use a combination of LLDPE and polypropylene.

It is preferable that opacity and whiteness of the polyethylene layer on the side coated with a porous layer are improved by incorporation of anatase type titanium oxide into polyethylene, as is widely employed in photographic paper. The proportion of titanium oxide is customarily 1-20 percent by weight with respect to polyethylene, and is preferably 2-25 percent by weight.

In the present invention, polyethylene coated paper is employed as a glossy paper. Further, it is possible to use polyethylene coated matte or silk surfaced paper, which is prepared as follows. When polyethylene is coated onto the surface of base paper employing melt extrusion, a matte or silk surface is formed on common photographic paper by employing so-called embossing treatments.

The amount of polyethylene used on the obverse and reverse sides of base paper is chosen so that the layer thickness of a water based liquid coating composition and curling under low humidity and high humidity after providing a back layer is optimized. In the present invention, the thickness of the polyethylene layer on the side coated with the water based coating composition is preferably in the range of 20-40 μm, while the thickness on the side coated with the back layer is preferably in the range of 10-30 μm.

Further, it is preferable that the aforesaid polyolefin coated paper supports exhibit the following characteristics.

1) Tensile strength: Strength specified in JIS P 8113 is preferably 2-300 N in the longitudinal direction and 10-200 N in the lateral direction,

2) Tear strength: Strength specified in JIS P 8116 is preferably 0.1-2 N in the longitudinal direction and 0.2-2 N in the lateral direction,

3) Compression modulus of elasticity: ≧1,030 N/cm,

4) Obverse side Bekk smoothness: At least 500 seconds under conditions specified in JIS P 8119 is preferable as a glossy surface, while that of so-called embossed products may be less than or equal to the above,

5) Reverse Side Bekk Smoothness: 100-800 seconds under conditions specified in JIS P 8119 are preferable,

6) Opacity: Under measurement conditions of a straight light incident/diffused light transmission, the transmittance of light in the visible region is preferably at most 20 percent and is particularly preferably at most 15 percent, and

7) Whiteness: Hunter whiteness specified in JIS P 8123 is preferably at least 80 percent. Further, when determined based on JIS Z 8722 (non-fluorescent objects) and JIS Z 8717 (containing fluorescent agents) and expressed by the color specification method specified in JIS Z 8730, L*, a* and b* are preferably 90-98, −5-+5, and −10-+5, respectively.

For improving adhesion to the porous layer, it is possible to provide a sublayer on the porous layer side of the aforesaid support. Binders of the sublayer are preferably hydrophilic polymers such as gelatin or polyvinyl alcohol and latex polymers at a Tg of −30 to 60° C. These binders are used in the range of 0.001-2 g per m² of the recording sheet. For an antistatic purpose, it is possible to incorporate into the sublayer a small amount of antistatic agents such as cationic polymers known in the art.

For the purpose of improving sliding properties and static charge characteristics, it is possible to provide a back layer on the side opposite the porous layer side of the aforesaid support. Binders of the back layer are hydrophilic polymers such as gelatin or polyvinyl alcohol and latex polymers at a Tg of 30-60° C. Further, it is possible to incorporate antistatic agents such as cationic polymers, various kinds of surface active agents, and in addition, matting agents of an average particle diameter of about 0.5- about 20 μm. The thickness of the back layer is commonly 0.1-1 μm, while when the back layer is provided to minimize curling, the aforesaid thickness is commonly in the range of 1-20 μm. Further, the back layer may be comprised of at least two layers.

It is possible to incorporate various kinds of additives into a water-based liquid coating composition to form the porous layer according to the present invention. Listed as such additives are, for example, cationic mordants, crosslinking agents, surface active agents (for example, cationic, nonionic, anionic and amphoteric surface active agents), white background color controlling agents, optical brightening agents, antifungal agents, viscosity modifiers, low-boiling point organic solvents, high-boiling point organic solvents, latex emulsions, anti-discoloring agents, UV absorbers, multivalent metal compounds (water-soluble or water-insoluble), matting agents, and silicone oil. Of these, in view of improving water resistance and moisture resistance after printing, it is preferable to use cationic mordants.

Employed as cationic mordants are polymer mordants having a primary, secondary or tertiary amino group, or a quaternary ammonium salt group. Of these, polymer mordants having a quaternary ammonium salt group are preferred due to minimal discoloration as well as minimal degradation of lightfastness during storage over an extended period of time.

Preferred polymer mordants are prepared in the form of homopolymers of monomers having the aforesaid quaternary ammonium salt group, or copolymers or condensation polymers with other monomers.

Employed as multivalent metal compounds usable in the present invention are, for example, sulfates, chlorides, nitrates, and acetates of Mg²⁺, Ca²⁺, Zn²⁺, Zr²⁺, Ni²⁺, and Al³⁺. Incidentally, inorganic polymer compounds such as basic polyaluminum hydroxide and zirconyl acetate are included in the examples of preferred water-soluble multivalent metal compounds. Many of these water-soluble compounds generally exhibit functions such as enhancement of lightfastness, bleeding resistance, and water resistance. The amount of these water-soluble multivalent metal ions used is commonly in the range of 0.05-20 millimoles per m² of the recording sheet and is preferably in the range of 0.1-10 millimoles.

In the production of the ink-jet recording sheet of the present invention, a coating method employed for applying a porous layer liquid coating composition onto a support may suitably be selected from those known in the art. For example, preferably employed are a gravure coating method, a roller coating method, a rod bar coating method, an air knife coating method, a spray coating method, an extrusion coating method, a curtain coating method, and an extrusion coating method employing a hopper, described in U.S. Pat. No. 2,681,294.

The porous layer related to the recording sheet of the present invention is comprised of at least two layers. In view of enhancing productivity, a method is preferred in which all the constituting layers are coated simultaneously.

Preferred thickness of dried porous ink receptive layers of the present invention are as follows:

an upper layer; 0.5 to 20 μm

an lower layer (or the total thickness of other layers than the upper layer); 10 to 60 μm.

The production method of the ink-jet recording sheet of the present invention is characterized as follows. Hydrophilic binders which undergo crosslinking by ionization radiation are incorporated into the porous layer. After coating the aforesaid porous layer, aforesaid hydrophilic binders undergo crosslinking by exposure to ionization radiation. Thereafter, production is carried out by drying the resulting layer.

Ionization radiation, as described herein, refers to, for example, electron beams, ultraviolet radiation, α-rays, β- rays, γ-rays, and X-rays. Of these, X-rays are preferred since they are less dangerous to humans, are easily handled, and are widely employed in industry.

Employed as light sources, for example, are low, middle, or high pressure mercury lamps having an operating pressure of several kPa—several MPa, and metal halide lamps. In view of the wavelength range of light sources, a high pressure mercury lamp or a metal halide lamp is preferred, and of these, the metal halide lamp is particularly preferred. Further, it is preferable to arrange a filter to cut radiation of a wavelength of 300 nm or shorter. The output of lamps is preferably 400 W-30 kW, while illuminance is preferably 10 mW/cm²-10 kW/cm². In the present invention, radiation energy is preferably 0.1-100 mJ/cm², and is more preferably 1-50 mJ/cm².

By setting the wavelength of a light source at 300 nm or longer and radiation energy at 100 mJ/cm² or less, it is possible to minimize decomposition of the mother nucleus of ionization radiation crosslinking resins, or various kinds of simultaneously added additives, whereby it is possible to overcome problems such as unpleasant odor due to decomposed substances. Further, by setting radiation energy at 0.1 mJ/cm² or more, it is possible to realize the desired crosslinking efficiency, whereby it is possible to further exhibit the desired effects of the present invention.

It is preferable that photopolymerization initiators and optical sensitizers are incorporated into the ink-jet recording sheet of the present invention. These compounds may be in a state dissolved in solvents or in a dispersed state, or may be chemically combined with hydrophilic binders which undergo crosslinking by ionization radiation.

Photopolymerization initiators and optical sensitizers usable in the present invention are not particularly limited, and any of those known in the art may be employed.

Listed as photopolymerization initiators and optical sensitizers may be, for example, benzophenones (e.g. benzophenone, hydroxybenzophenone, bis-N,N-dimethylaminobenzophenone, bis-N,N-diethylaminobenzophenone, and 4-methoxy-4′-dimethylaminobenzophenone); thioxanthones (e.g. thioxanthone, 2,4-diethylthioxanthone, isopropylthioxanthone, chlorothioxanthone, and isopropoxychlorothioxanthone); anthraquinones (e.g. ethylanthraquinone, benzanthraquinone, aminoanthraquinone, and chloroanthraquinone); acetophenones; benzoin ethers (e.g. benzoin methyl ether); 2,4,6-trihalomethyltriazines 1-hydroxycyclohexyl phenyl ketone; a 2-(o-chlorophenyl)-4,5-diphenylimidazole dimer, a 2-(o-chlorophenyl)-4,5-di(m-methoxyphenyl)imidazole dimer, a 2-(o-fluorophenyl)-4,5-phenylimidazole dimer, a 2-(o-methoxyphenyl)-4,5-phenylimidazole dimer, 2-(p-methoxyphenyl)-4,5-diphenylimidazole dimer, a 2,-di(p-methoxyphenyl)-5-phenylimodazole dimer, a 2,4,5-triarylimidazole dimer of 2-(2,4-dimethoxyphenyl)-4,5-diphenylimidazole dimer, benzyldimethylketal, 2-benzyl-2-dimethylamino-1-(4-morpholinophenyl)-butane, 2-methyl-1-[4-(methylthio)phenyl]-2-morpholino-1-propane, 2-hydoxy-2-methyl-1-phenyl-propane-1-one, 1-[4-(2-hydroxyethoxy)-phenyl]-2-hydroxy-2-methyl-1-propane-1-one, phenanthorenequinone, 9,10-phenanthorenequinone; benzoins (e.g. methylbenzoin and ethylbenzoin); acridine derivatives (e.g. 9-phenylacridine, 1,7-bis(9,9′-acridinyl)heptane); and bisacylphosphine oxide. The aforesaid compounds may be employed individually or in combinations.

In addition to the aforesaid photopolymerization initiators, it is possible to add polymerization accelerators. Listed as polymerization accelerators may be, for example, ethyl p-dimethylaminobenzoate, isoamyl p-dimethylaminobenzoate, ethanolamine, diethanolamine, and triethanolamine.

### EXAMPLES

The present invention will now be described with reference to examples. However, the present invention is not limited thereto. Incidentally, “%” in the examples is percent by weight, unless otherwise specified.

<<Preparation of Minute Inorganic Particle Dispersion S-1-S-3>>

Each of Minute Inorganic Particles 1-3 described below was gradually added while stirring and dispersed into a 1% aqueous methanol solution, employing a high speed stirring homogenizer. After adjusting the pH of the resulting dispersion to 4.0, the total weight was made to 100 g by the addition of pure water, whereby each minute inorganic particle dispersion, at a concentration of silica solids of 25%, was prepared. Subsequently, after dispersing the resulting dispersion employing a sand mill while suitably controlling the dispersion time, filtration was carried out employing a TCP-10 Type filter, manufactured by Advantech Toyo Co., Ltd., whereby Minute Inorganic Particle Dispersions S-1-S-3, comprised of the secondary particles of the average particle diameter described below, were prepared.

Further, the average secondary particle diameter and the average primary particle diameter shown below are values determined as follows. Each minute organic particle dispersion was diluted by a factor of 50, and the aforesaid diameter was determined employing a dynamic light scattering system particle size measuring apparatus, being a Zeta Sizer 1000HS (manufactured by Malvern Inc.).

Minute Inorganic Particle Dispersion S-1: average secondary particle diameter=80 nm, Minute Inorganic Particles 1=gas phase method silica (at an average primary particle diameter of 30 nm),

Minute Inorganic Particle Dispersion S-2: average secondary particle diameter=40 nm, Minute Inorganic Particles 2=gas phase method silica (at an average primary particle diameter of 7 nm), and

Minute Inorganic Particle Dispersion S-3: average secondary particle diameter=45 nm, Minute Inorganic Particles 3=gas phase method alumina (at an average primary particle diameter of 13 nm)

<<Preparation of Recording Sheets>>

(Preparation of Porous Layer Liquid Coating Compositions)

(Preparation of Porous Layer Liquid Coating Composition T-1)

While stirring, gradually added to Minute Inorganic Particle Dispersion S-1 (at an average secondary particle diameter of silica of 80 nm) were 25 g of UV Radiation Polymerizing Type Polyvinyl Alcohol Derivative 1 (A-2; a degree of polymerization of the main chain PVA of 3,000, a saponification ratio of 88%, and a crosslinking group modification ratio of 1%), and 0.05 g of Photopolymerization Initiator 1 (Kayacure QTX, manufactured by Nihon Kayaku Co., Ltd.). Subsequently, the weight of the resulting mixture was adjusted to 200 g by the addition of pure water, whereby Porous Layer Liquid Coating Composition T-1 was prepared. (Preparation of Porous Layer Liquid Coating Compositions T-2 and T-3)

Porous Layer Liquid Coating Compositions T-2 and T-3 were prepared in the same manner as aforesaid Porous Layer Liquid Coating Composition T-1, except that Minute Inorganic Particle Dispersion S-1 was replaced respectively with Minute Inorganic Particle Dispersion S-2 (at an average secondary particle diameter of silica of 40 nm), and Minute Inorganic Particle Dispersion S-3 (at an average secondary particle diameter of silica of 40 nm), both prepared as above. (Preparation of Recording Sheet A-1)

Porous Layer Liquid Coating Composition T-1, prepared as above, was applied as a lower layer onto a polyethylene coated paper (comprising 8% anatase type titanium oxide in polyethylene on the porous layer side, a 0.05 g/m² gelatin sublayer on the porous layer side, and a 0.2 g/m2 back layer comprising a latex polymer at a Tg of about 80° C. on the side opposite the porous layer), which was prepared by covering both sides of 170 g/m² thick base paper with polyethylene, at a wet layer thickness of 60 μm, employing a slide hopper type coater. Porous Layer Liquid Coating Composition T-1, prepared as above, was also simultaneously applied as an upper layer onto the lower layer at a wet layer thickness of 20 μm. Thereafter, ultraviolet radiation at an energy level of 50 mJ/cm² was exposed to the resulting coating, employing a metal halide lamp having a dominant wavelength of 365 nm. Subsequently, the exposed coating was dried employing an 80° C. hot air type oven, whereby Recording Sheet A-1 was prepared.

(Preparation of Recording Sheets A-2-A-5)

Recording Sheets A-2-A-5 were prepared in the same manner as aforesaid Recording Sheet A-1, except that each of the upper layer and lower layer liquid coating compositions was replaced with the composition described in Table 1.

Incidentally, r₁/r₂ described in Table 2 refers to the ratio of average secondary particle diameter r₁ in the upper layer to average secondary particle diameter r₂ in the lower layer.

TABLE 1

| | | | | | | | Upper | |
|---|---|---|---|---|---|---|---|---|
| | Lower Layer | | | Upper Layer | | | Layer/Lower | |
| | Porous | | | Porous | | | Layer | |
| | Layer | Wet- | Dried | Layer | Wet- | Dried | Secondary | |
| | Liquid | layer | layer | Liquid | layer | layer | Particle | |
| Recording | Coating | Thickness | Thickness | Coating | Thickness | Thickness | Diameter | |
| Sheet No. | Composition | (μm) | (μm) | Composition | (μm) | (μm) | Ratio r₁/r₂ | Remarks |
| A-1 | T-1 | 60 | 16 | T-1 | 20 | 5.3 | 1.00 | Comp. |
| A-2 | T-2 | 60 | 16 | T-2 | 20 | 5.5 | 0.50 | Inv. |
| A-3 | T-3 | 60 | 16 | T-3 | 20 | 5.6 | 0.56 | Inv. |
| A-4 | T-2 | 60 | 17 | T-2 | 20 | 5.5 | 1.00 | Comp. |
| A-5 | T-3 | 60 | 18 | T-3 | 20 | 5.6 | 1.00 | Comp. |

(Preparation of Recording Sheets B-1-B-5)

Recording Sheets B-1-B-5 were prepared in the same manner as aforesaid Recording Sheets A-1-A-5, except that Ultraviolet Radiation Polymerizing Type Polyvinyl Alcohol Derivative 1, which was employed to prepare each of the porous layer liquid coating compositions, was replaced with Ultraviolet Radiation Polymerizing Type Polyvinyl Alcohol Derivative 2 (being the compound represented by General Formula (2), at a degree of polymerization of the main chain PVA of 4,000, a saponification ratio of 88%, and a crosslinking group modification ratio of 5.0 mol %).

(Preparation of Recording Sheets C-1-C-5)

Recording Sheets C-1-C-5 were prepared in the same manner as aforesaid Recording Sheets A-1-A-5, except that Ultraviolet Radiation Polymerizing Type Polyvinyl Alcohol Derivative 1, which was employed to prepare each of the porous layer liquid coating compositions, was replaced with polyvinyl alcohol (at a degree of 3,000, and a saponification ratio of 88%, and 0.03 g of boric acid was added while not exposed to ultraviolet radiation.

Each recording sheet prepared as above was stored at 40° C. for 3 days, and thereby stabilized.

<<Evaluation of Each Characteristic of Recording Sheets>>

Each recording sheet prepared as above was subjected to each evaluation based on the methods below.

(Evaluation of Cracking Resistance)

The image forming surface of each recording sheet prepared as above was observed employing a hand-held magnifier and the number of cracks per 10 cm² on the layer surface was recorded. The resulting number was utilized as a scale of cracking resistance.

(Measurement of 60-Degree Glossiness)

The 60-degree specular glossiness of each image forming surface was determined in accordance with JIS Z 8741. A variable angle gloss meter (VGA-1001DP), manufactured by Nihon Denshoku Industries Co., Ltd., was employed for the measurement.

Incidentally, recording sheets denoted by a code of * in the evaluation results of Table 2 resulted in many cracks on the measured surface, whereby it was impossible to determine the 60-degree specular glossiness.

(Evaluation of Ink Absorbability)

A solid neutral gray image at a reflection density of approximately 1.0 was printed employing an ink-jet printer PM900C, manufactured by Seiko Epson Corp., and ink absorbability was evaluated based on the criteria below.

A: unevenness was not noted on the solid image surface

B: slight unevenness was noted, but the quality remained viable for practical use

C: when the solid image surface was carefully observed, recognizable unevenness was noted, but the quality remained viable for practical prints

D: gray unevenness was clearly noted on the solid image surface and the quality was not commercially viable

E: marked color unevenness was noted on the solid image surface and the quality was not commercially viable

In the aforesaid evaluation rankings, a rank of C or above was judged to be commercially viable quality.

(Evaluation of Folding and Fracture Resistance)

Each of the aforesaid recording sheets was cut into 5 mm×10 cm strips. Subsequently, each strip was wound around a cardboard core of a core interior diameter of 3 cm at 23° C. and 55 percent relative humidity so that the porous layer faced out. After one hour, the strip was released. The image forming surface side was then observed employing a hand-held magnifier and the number of cracks due to folding and fracture was recorded. Folding and fracture resistance was evaluated based on the criteria below.

A: no folds and fractures were noted

B: the number of folds and factures ranged from 1 to 5

C: the number of folds and fractures ranged from 6 to 19

D: the number of folds and fractures ranged from 20 to 99

E: the number of folds and fractures exceeded 100

In the aforesaid rankings, a rank C or above was judged to be commercially viable.

(Dimensional Stability)

Each recording sheet was cut into A4 size sheets, and the cut sheets were placed on a horizontal surface at 23° C. and 20 percent relative humidity for one day. Thereafter, the height (mm) of curl (rise from the supporting surface) at the four corners was determined and the average value (mm) of the four corners was calculated. Dimensional stability was then evaluated based on the criteria below.

A: the average height was less than 3 mm

B: the average height was between 3 and 10 mm

C: the average height was between 10 and 30 mm

D: the average height was at least 30 mm

E: the recording sheet was cylindrical, whereby it was impossible to achieve measurements

Table 2 shows the results.

TABLE 2

| | Each Evaluation Result | | | | | |
|---|---|---|---|---|---|---|
| | | | | Folding and | | |
| Recording | Cracking | 60-degree | Ink | fracture | Dimensional | |
| Sheet No. | resistance | Glossiness | Absorbability | resistnace | Stability | Remarks |
| A-1 | 0 | 40 | B | C | C | Comp. |
| A-2 | 0 | 68 | A | A | A | Inv. |
| A-3 | 0 | 75 | A | A | A | Inv. |
| A-4 | 0 | 65 | C | C | B | Comp. |
| A-5 | 0 | 62 | D | C | B | Comp. |
| B-1 | 12 | 41 | B | D | C | Comp. |
| B-2 | 6 | 66 | B | B | B | Inv. |
| B-3 | 7 | 70 | B | B | B | Inv. |
| B-4 | 18 | 64 | C | E | C | Comp. |
| B-5 | 16 | 61 | C | E | C | Comp. |
| C-1 | 56 | * | C | C | B | Comp. |
| C-2 | 103 | * | E | D | E | Comp. |
| C-3 | 119 | * | E | D | E | Comp. |
| C-4 | 152 | * | D | E | C | Comp. |
| C-5 | 134 | * | D | E | C | Comp. |

Comp.; Comparative Example
Inv.; Present Invention

As can clearly be seen from Table 2, the recording sheets of the present invention, which were constituted in such a manner that the average secondary particle diameter of minute inorganic particles in the aforesaid porous layer occupied the upper portion was less than that in the porous layer positioned at the lower portion, exhibited excellent cracking resistance, 60-degree glossiness, ink absorbability, folding and fracture resistance, and dimensional stability, compared to the comparative examples. Further, the aforesaid effects of the present invention were more pronounced by employing the hydrophilic binders at a degree of polymerization of at least 500 and a crosslinking group modification ratio of at least 4 mol percent.

According to the present invention, it is possible to provide an ink-jet recording sheet having a porous layer which tends to not result in cracking during production, and exhibits excellent ink absorbability, wet curl resistance, and folding and fracture resistance, and a production method of the same.

What is claimed is:

1. An ink-jet recording sheet comprising a support having thereon a first porous ink receptive layer and a second porous ink receptive layer in that order, the first porous ink receptive layer and the second porous ink receptive layer each containing,
(i) inorganic microparticles; and
(ii) a hydrophilic binder which is cross-linked by irradiation with ionization radiation,
wherein an average particle diameter of second particles of the inorganic microparticles in the second porous ink receptive layer is smaller than an average particle diameter of second particles of the inorganic microparticles in the first porous ink receptive layer.

2. The ink-jet recording sheet of claim 1, wherein a polymerization degree of the hydrophilic binder is not smaller than 500 and a ratio of cross-linking conversion of the hydrophilic binder is not more than 4 mol % based on the total mol of the hydrophilic binder.

3. The ink-jet recording sheet of claim 1, wherein the first porous ink receptive layer and the second porous ink receptive layer are provided using a simultaneous multilayer coating method.

4. The ink-jet recording sheet of claim 1, wherein the inorganic microparticles contained in the second porous ink receptive layer are silica or alumina.

5. The ink-jet recording sheet of claim 1, wherein the first porous ink receptive layer and the second porous ink receptive layer each has a void volume per unit area of 15-40 ml/m².

6. The ink-jet recording sheet of claim 1, wherein the support is a non-absorptive support.

7. An ink-jet recording sheet comprising a support having thereon a first porous ink receptive layer and a second porous ink receptive layer in that order, the first porous ink receptive layer and the second porous ink receptive layer each containing,
(i) inorganic microparticles; and
(ii) a hydrophilic binder which is cross-linked by irradiation with ionization radiation,
wherein an average particle diameter of second particles of the inorganic microparticles in the second porous ink receptive layer is smaller than an average particle diameter of second particles of the inorganic microparticles in the first porous ink receptive layer; a polymerization degree of the hydrophilic binder is not smaller than 500 and a ratio of cross-linking conversion of the hydrophilic binder is not more than 4 mol % based on the total mol of the hydrophilic binder; and the first porous ink receptive layer and the second porous ink receptive layer are provided using a simultaneous multilayer coating method.

8. The ink-jet recording sheet of claim 7, wherein the inorganic microparticles contained in the first porous ink receptive layer are silica or alumina.

9. The ink-jet recording sheet of claim 8, wherein the first porous ink receptive layer and the second porous ink receptive layer each has a void volume of per unit area of 15-40 ml/m².

10. The ink-jet recording sheet of claim 9, wherein the support is a non-absorptive support.

11. A method for producing an ink-jet recording sheet comprising the steps of:
(a) coating simultaneously a first composition and a second composition on a support so as to obtain a first porous ink receptive layer and a second porous ink receptive layer, the first composition and the second composition each containing,
(i) inorganic microparticles; and
(ii) a hydrophilic binder;
(b) irradiating the porous ink receptive layers with ionization radiation so as to cross-link the hydrophilic binder; and
(c) drying the porous ink receptive layers,
wherein an average particle diameter of second particles of the inorganic microparticles in the second porous ink receptive layer is smaller than an average particle diameter of second particles of the inorganic microparticles in the first porous ink receptive layer.

12. The method for producing an ink-jet recording sheet of claim 11, wherein a polymerization degree of the hydrophilic binder is not smaller than 500 and a ratio of cross-linking conversion of the hydrophilic binder is not more than 4 mol % based on the total mol of the hydrophilic binder.

13. The method for producing an ink-jet recording sheet of claim 11, wherein the irradiating step (b) is carried out when a density of a solid portion in the porous ink receptive layers is in a range of 5 to 90 weight % based on the total weight of the porous ink receptive layers.

14. The method for producing an ink-jet recording sheet of claim 11, wherein the inorganic microparticles contained in the second porous ink receptive layer are silica or alumina.

15. The method for producing an ink-jet recording sheet of claim 11, wherein the first porous ink receptive layer and the second porous ink receptive layer each has a void volume of per unit area of 15-40 ml/m².

16. The method for producing an ink-jet recording sheet of claim 11, wherein the support is a non-absorptive support.

17. A method for producing an ink-jet recording sheet comprising the steps of:
(a) coating simultaneously a first composition and a second composition on a support so as to obtain a first porous ink receptive layer and a second porous ink receptive layer, the first composition and the second composition each containing,
(i) inorganic microparticles; and
(ii) a hydrophilic binder;
(b) irradiating the porous ink receptive layers with ionization radiation so as to cross link the hydrophilic binder; and
(c) drying the porous ink receptive layers,
wherein an average particle diameter of second particles of the inorganic microparticles in the second porous ink receptive layer is smaller than an average particle diameter of second particles of the inorganic microparticles in the first porous ink receptive layer; and a polymerization degree of the hydrophilic binder is not smaller than 500 and a ratio of cross-linking conversion of the hydrophilic binder is not more than 4 mol % based on the total mol of the hydrophilic binder,
wherein the irradiating step (b) is carried out when a density of a solid portion in the porous ink receptive layers is in a range of 5 to 90 weight % based on the total weight of the porous ink receptive layers.

18. The method for producing an ink-jet recording sheet of claim 17, wherein the inorganic microparticles contained in the second porous ink receptive layer are silica or alumina.

19. The method for producing an ink-jet recording sheet of claim 18, wherein the first porous ink receptive layer and the second porous ink receptive layer each has a void volume per unit area of 15-40 ml/m².

20. The method for producing an ink-jet recording sheet of claim 19, wherein the support is a non-absorptive support.
